(19) United States
(12) Patent Application Publication
(10) Pub. No.: US 2009/0193625 A1
(43) Pub. Date: Aug. 6, 2009

(54) DRAWER HANDLE WITH IMPROVED STRUCTURE

(76) Inventor: Taiyuan Yu, Xiamen (CN)

Correspondence Address: Dr. BANGER SHIA;Int''l Patent Office of Bang Shia, 102 Lindencrest Ct, Sugar Land, TX, 77479-5201, US

(21) Appl. No.: 12/168,130

(22) Filed: Jul. 5, 2008

(30) Foreign Application Priority Data
Feb. 3, 2008 (CN) 200820101395.4

(51) Int. Cl. E05B 1/00

(52) U.S. Cl. 16/417

(57) ABSTRACT

The present invention pertains to a drawer handle with improved structure mainly consisted of a hollow head, a weight unit, and a main base; wherein, the hollow head includes an opening for being inserted by the main base, which further has a tapped aperture disposed thereon and a protrusion with a slotted portion protruded therefrom for mounting into the hollow head. Further, the weight unit has its bottom side to be disposed against an inner surface of the protrusion so as to well embed the slotted portion into the opening of the hollow head while assembling the main base with the hollow head. In this manner, the present invention conduces to obtain a substantial weight without increasing the manufacturing cost and enhance the quality of the integral handle product.

### BACKGROUND OF THE INVENTION

1. Field of the Invention

The present invention relates to a furniture design, particularly to a drawer handle with improved structure.

2. Description of the Related Art

‘A good horse deserves a good saddle’ is a proverb indicating that a splendid furniture usually fits with a splendid component, for instance that the drawer applied for the high-class furniture often disposes a copper handle or a handle made of other metal on it so as to perform the gorgeous and luxury of the furniture. Typically, the conventional copper handles are accustomed to being used in following descriptions.

Referring to FIG. 1 to FIG. 3, the conventional drawer handle 10 wholly fabricated of copper material includes an aperture 11 so that the handle 10 can be secured to the drawer (not shown) by fastening a screw through it. Due to the handle 10 formed integral with the copper solid, it gets weight while gripping, which however results in increasing the manufacturing cost.

Therefore, another conventional hollow handle 20 shown in FIG. 4 to FIG. 7 solves the problem of the solid handle 10. It essentially comprises of a separate hollow head 21 and a base 22, wherein, the hollow head 21 has an opening for the base 22 to mounted therein, and the base 22 further has a screwed hole 25, a protrusion 23 to embedding into the head 21, and a slotted section 24 disposed on the protrusion 23. While assembling the hollow head 21 with the base 22, the slotte section 24 hence can be firmly fixed in the opening so as to generate an integral handle 20, which is then secured to the drawer. Nevertheless, the protrusion 23 would be easily deformed or incurved while being subjected to a forced pressure or an outer bump, which may hence causes the hollow head 21 to be easily taken away from the base 22 in time of using or pulling. In addition, the hollow handle 20, however, is not as weighed as the solid handle 10 so that it would also change of shape under the outer impact and affect the outer appearance. Therefore, the conventional handle 20 still needs improvement.

### SUMMARY OF THE INVENTION

The object of the present invention is to provide a drawer handle with improved structure which is conducive to obtaining a substantial weight without increasing manufacturing cost and improving the quality of the product to ensure the normal use.

Another object of the present invention is to prevent the hollow head and the protrusion of the main base from being out of shape while being subjected to the outer force.

The drawer handle with improved structure in accordance with the present invention essentially comprises a hollow head, a main base, and a weight unit; wherein, the hollow head defines an opening thereon, and the main base includes a tapped aperture and a protrusion with a slotted portion protruded therefrom. Further, the bottom side of the weight unit is disposed against an inner surface of the protrusion so as to firmly mount the weight unit on the main base, and the slotted portion is embedded into the opening of the hollow head while inserting the main base into the hollow head. In this manner, the weight unit positioned between the hollow head and the main base assists in efficiently preventing the protrusion and the hollow head from being deformed or incurved by impacting forces and avoiding the separation of the head and the base while pulling the handle. Further, the hollow head and the main base can be both made of copper material, except the weight unit made of other metal material. Therefore, the present invention facilitates to promote the handle quality for keeping a good appearance and ensuring the normal use, decrease the manufacturing cost, and increase the substantial weight of the handle.

The advantages of the present invention over the known prior arts will become more apparent to those of ordinary skilled in the art by reading the following descriptions with the relating drawing.

### BRIEF DESCRIPTION OF THE DRAWINGS

FIG. 1 is a side view showing a conventional handle;

FIG. 2 is a rear view showing of FIG. 1;

FIG. 3 is a cross-sectional view showing of FIG. 1;

FIG. 4 is an exploded view showing another conventional handle;

FIG. 5 is a side view showing of FIG. 4;

FIG. 6 is a rear view showing of FIG. 4;

FIG. 7 is a cross-sectional view showing of FIG. 4;

FIG. 8 is an exploded view showing a first preferred embodiment of the present invention;

FIG. 9 is a side view showing of FIG. 8;

FIG. 10 is a rear view showing of FIG. 8;

FIG. 11 is a cross-sectional view showing of FIG. 8;

FIG. 12 is an exploded view showing a second preferred embodiment of the present invention;

FIG. 13 is a side view showing of FIG. 12;

FIG. 14 is a rear view showing of FIG. 12; and

FIG. 15 is a cross-sectional view showing of FIG. 12;

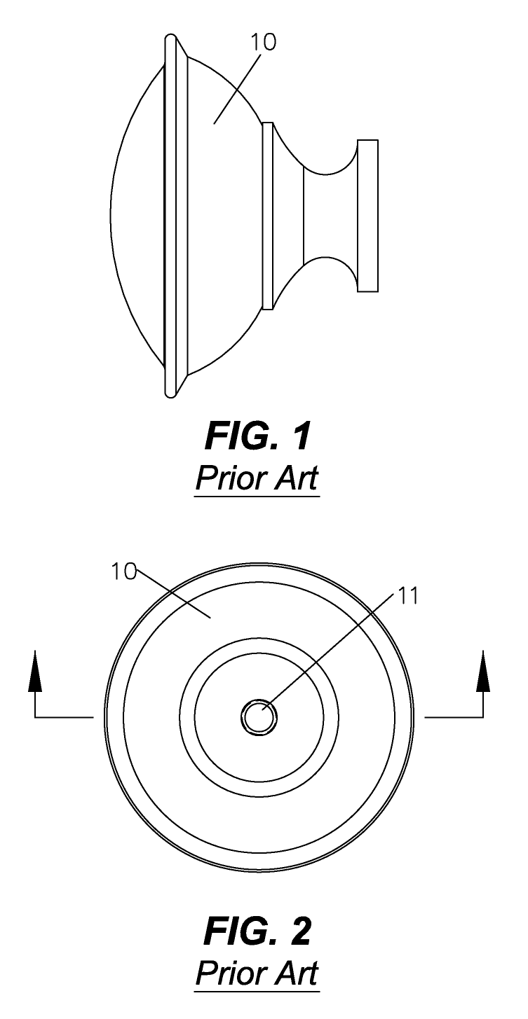

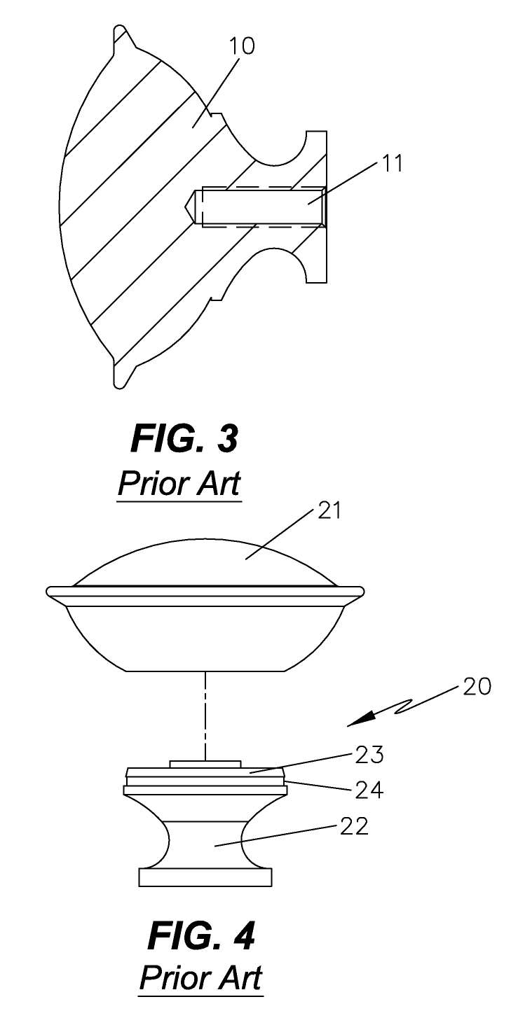

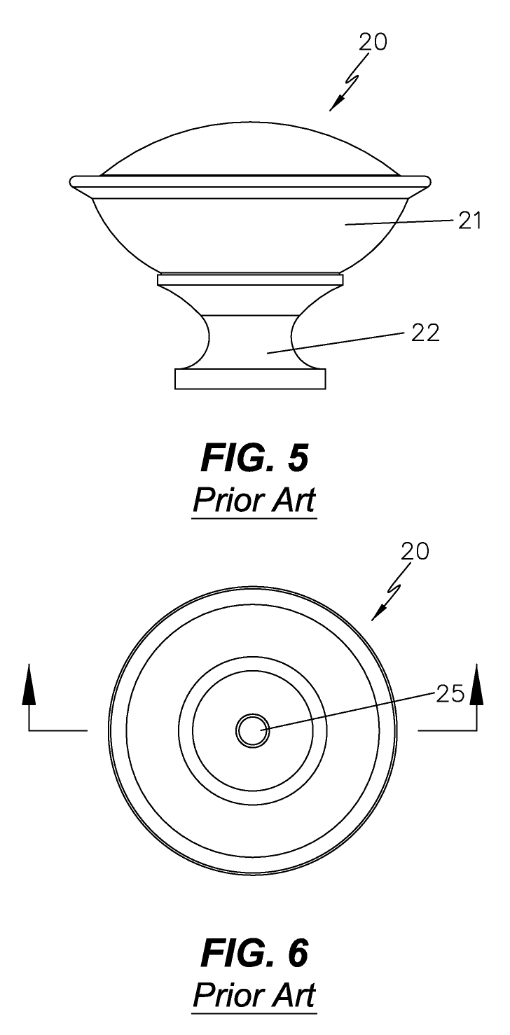

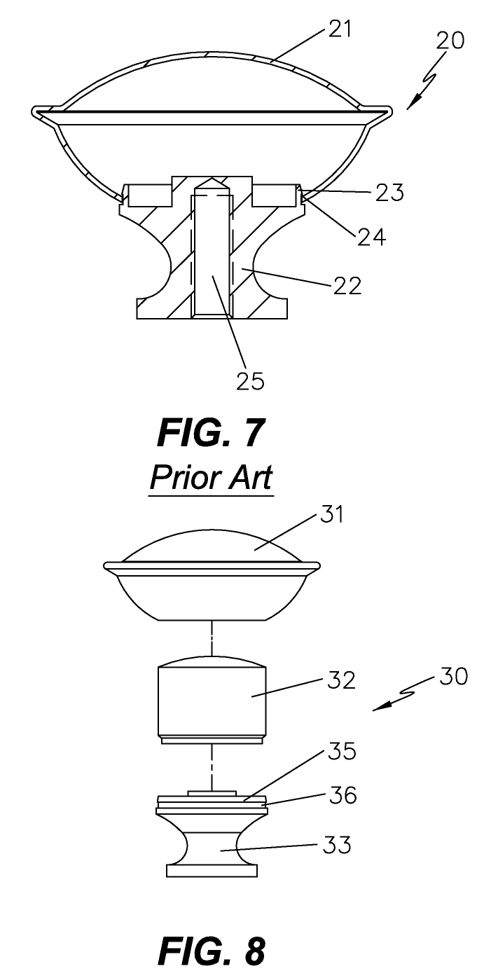

### DETAILED DESCRIPTION OF THE PREFERRED EMBODIMENTS

Before the present invention is described in greater detail, it should be noted that the like elements are denoted by the same reference numerals throughout the disclosure.

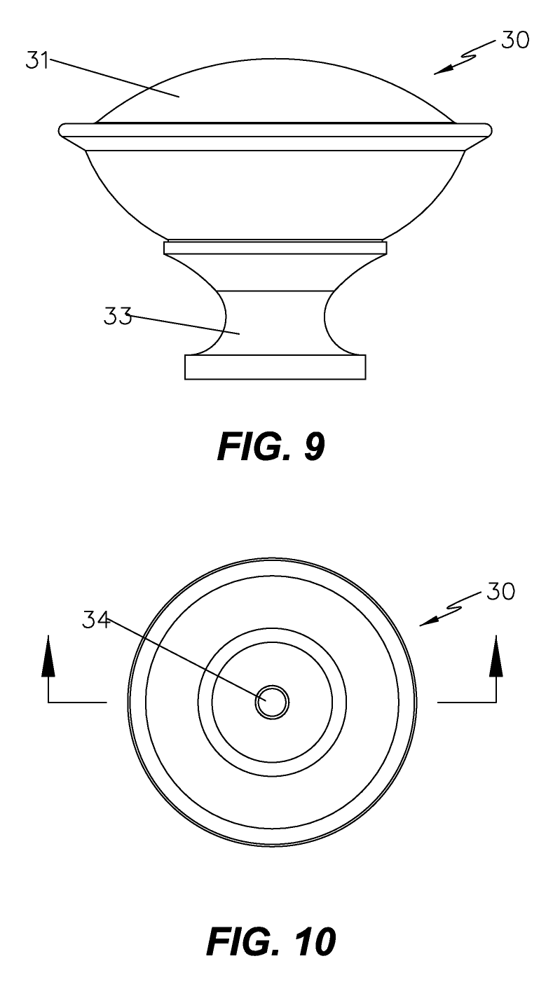

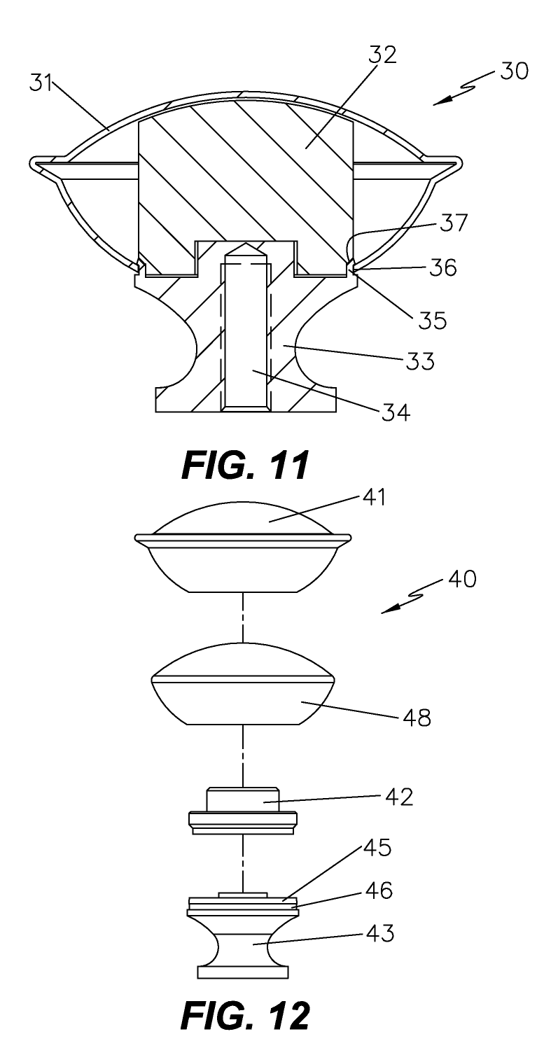

Referring to FIG. 8 through FIG. 11, a drawer handle 30 of a first preferred embodiment of the present invention comprises a hollow head 31, a main base 33, and a weight unit 32; wherein, the hollow head 31 provides with an opening for assembling with the main base 33, and the main base 33 includes a tapped aperture 34 disposed thereon and a protrusion 35 protruded therefrom for mounting into the hollow head 31. The protrusion 35 further provides with a slotted portion 36 arranged thereon. Particularly, the weight unit 32 has a bottom side thereof to be disposed against an inner surface of the protrusion 35 so as to position the weight unit 32 on the main base 33. Additionally, the protrusion 35 has its top end to be sloped outward while inserting the bottom side of the weight unit 32 into the main base 33, and the weight unit 32 also provides with a stair-stepped portion 37 formed on its bottom side. The stair-stepped portion 37 herein is adopted to present in a slant type, so that the protrusion 35 is sloped outward under the pressure of the stair-stepped portion 37 while mounting the weight unit 32 on the main base 33.

While in assembling the hollow head 31 with the main base 33, the weight unit 32 is straight located between the hollow head 31 and the main base 33, whereby the top side of the weight unit 32 exactly directs against the inner wall of the hollow head 31 and the opening of the head 31 well fits with the slotted portion 36 of the protrusion 35. Simultaneously, the stair-stepped portion 37 of the weight unit 32 forces both top ends of the protrusion 35 to perform in an outward inclination and renders the top ends thereof to be fitly leaned against the inner surface of the opening of the hollow head 31, thereby firmly fastening the main base 33 into the hollow head 31 and efficiently preventing the problem of the deformation of the protrusion 35 and the hollow head 32 due to the unintentional bump and of the separation of the hollow head 31 from the main base 33 in time of pulling, hence ensuring the normal use of the handle 30.

Still further, for obtaining a better quality of the handle 30, it is adopted in the present invention that the hollow head 31 and the main base 33 are fabricated of copper materials, and the weight unit 32 can be simply made of other common metal materials. Therefore, the present invention can not only maintain a good appearance but also increase the substantial weight of the handle with less manufacturing cost.

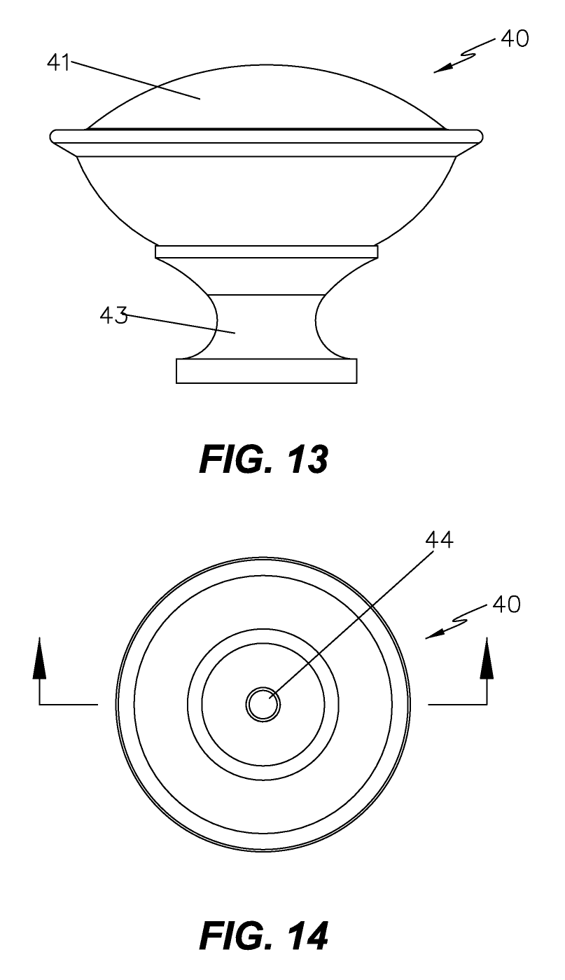

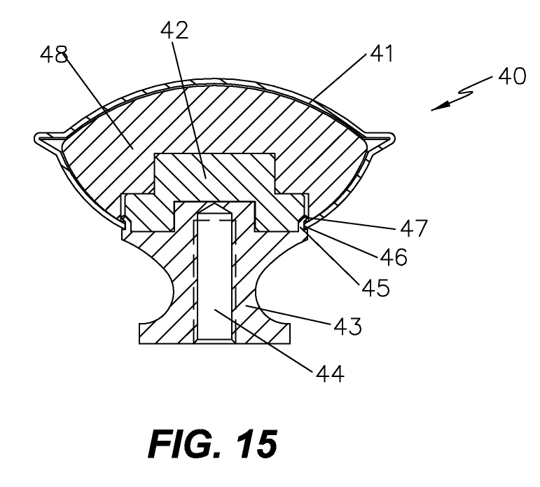

Referring to FIG. 12 through FIG. 15, a drawer handle 40 of a second preferred embodiment of the present invention still comprises a hollow head 41, a weight unit 42, and a main base 43. The concatenation of the above three elements are as the same as the previous embodiment and herein are omitted. Differentially, an anti-magnetic zinc alloy member 48 is filled with the interstices formed between a top side of the the weight unit 42 and an inner wall of the hollow head 41 when the weight unit 42 is fabricated of iron material.

While in assembling the hollow head 41 with the main base 43, the the opening of the head 41 can be well fit with the slotted portion 46 of the protrusion 45. Simultaneously, the stair-stepped portion 47 of the weight unit 42 forces both top ends of the protrusion 45 to perform in an outward inclination and renders the top ends to be fitly leaned against the inner surface of the opening, thereby firmly fastening the main base 43 into the hollow head 41. Further, the anti-magnetic zinc alloy member 48 disposes its end face to densely contact with the inner wall of the hollow head 41 and fully encloses the weight unit 42 so as to eliminate the outer magnetism, prevent the attraction of the magnet and the handle 40, and provide supports to avoid the deformation of the hollow head 41.

To sum up, the present invention takes advantages of the increment of the weight unit that is located between the hollow head and the main base by disposing its bottom side against the inner side of the protrusion, thereby preventing the deformation of the protrusion and avoiding the separation of the head from the main base. Further, the anti-magnetic zinc alloy member surrounding the weight unit also assists in eliminating the attraction of the magnetism. Therefore, the present invention facilitates to obtain a substantial weight without increasing the cost, improve the quality of the product to ensure the normal use, and maintain a good appearance of the handle.

While we have shown and described the embodiment in accordance with the present invention, it should be clear to those skilled in the art that further embodiments may be made without departing from the scope of the present invention.

I claim:

1. A drawer handle with improved structure mainly comprising a hollow head, a main base, and a weight unit; wherein, said hollow head providing with an opening for assembling with said main base; said main base including a tapped aperture disposed thereon and a protrusion, providing with a slotted portion, protruded from said main base for mounting into said hollow head; said weight unit having a bottom side thereof to be disposed against an inner surface of said protrusion so that said weight unit being firmly positioned on said main base, and said slotted portion of said protrusion being embedded into said opening of said hollow head while inserting said main base into said hollow head.

2. The drawer handle as claimed in claim 1, wherein, a stair-stepped portion is formed on said bottom side of said weight unit and adapted to said protrusion of said main base.

3. The drawer handle as claimed in claim 2, wherein, said stair-stepped portion performs in a slant statement.

4. The drawer handle as claimed in claim 3, wherein, said protrusion of said main base has a top end thereof to be sloped outward while inserting said bottom side of said weight unit into said main base.

5. The drawer handle as claimed in claim 1, wherein, said weight unit has a top side thereof to direct against an inner wall of said hollow head.

6. The drawer handle as claimed in claim 1, wherein, there are interstices between a top side of said weight unit and an inner wall of said hollow head.

7. The drawer handle as claimed in claim 1, wherein, said weight unit is fabricated of iron material, and interstices formed between a top side of said weight unit and an inner wall of said hollow head are filled with an anti-magnetic zinc alloy member.
